(19) United States
(12) Patent Application Publication
(10) Pub. No.: US 2026/0015029 A1
(43) Pub. Date: Jan. 15, 2026

(54) Beach Skis

(71) Applicants: Paul Markus, Rocky Point, NC (US); Lacey Markus, Rocky point, NC (US)

(72) Inventors: Paul Markus, Rocky Point, NC (US); Lacey Markus, Rocky point, NC (US)

(21) Appl. No.: 18/767,077

(22) Filed: Jul. 9, 2024

(51) Int. Cl. B62B 19/02

(52) U.S. Cl. CPC B62B 19/02

(57) ABSTRACT

The Beach Ski is a device that is comprised of a ski made of either a biodegradable wood or a plastic or PVC material depending on the preference of the consumer and a velcro strap that will secure the ski to the bottom of the wheel/tire of a the wagon, cooler, small trailer or any other small item with wheels/tires that does not have the availability to easily roll over sand or soft surfaces. The skis will aid in the transport of items that are needed for a day at the beach from your vehicle to the beach with ease by assisting the wheeled item in sliding/gliding/moving over the sand or any other soft, loose material.

### FEDERALLY SPONSORED RESEARCH AND DEVELOPMENT

Not Applicable

### CROSS-REFERENCE TO RELATED APPLICATIONS

Not Applicable

### JOINT RESEARCH AGREEMENT

Not Applicable

### REFERENCE TO A “SEQUENCE LISTING”, A TABLE, OR A COMPUTER PROGRAM LISTING APPENDIX SUBMITTTED ON A COMPACT DISC AND AN INCORPORATION-BY-REFERENCE OF THE MATERIAL ON THE COMPACT DISC

Not Applicable

### PRIOR ART

Not Applicable

### BACKGROUND OF THE INVENTION

This device relates to being able to transport the items you need for a fun day at the beach from your vehicle to the area on the beach of your choice with ease.

There are many beach going wagons on the market, but even though it states that they can easily traverse the beach/sand this has been proven very difficult for a wide array of individuals.

As a family we like to go to the beach. We purchased a wagon that claimed to be easily used on sand at the beach. We no longer use this wagon at the beach because we would end up dragging the wagon through the sand instead of it rolling over the top.

Every time we go to the beach, we see many other individuals struggling with their wagons as we did through the soft sand on the beach, trying to get all their items to where they want to relax, play and set up, which created the idea of the Beach Skis.

We created this device so you can change your ordinary wheeled wagon to a wagon with skis for easy transport of personal items across the soft sand or any other soft material in just a few easy steps.

This device is a ski that can be attached to each individual wheel/tire of a wagon, cooler, small trailer or any other small item with wheels/tires that you need to easily slide/glide/move on the sand attaching with a velcro strap.

Due to how much waste and non-biodegradable material enters our waterways and oceans we wanted to design this product with the environment in mind. The Beach Skis are made to be reusable or biodegradable/disposable depending on the choice of the consumer.

### SUMMARY OF THE INVENTION

This device is a ski that can be attached with a velcro strap to each individual wheel/tire of a wagon, cooler, small trailer or any other small item with wheels/tires that you need to easily slide/glide/move on the sand or any other soft, loose surface.

### BRIEF DESCRIPTION OF DRAWINGS

Even though the characteristics of this device will be explained in the claims section, the device itself and how it will be made and used will be better understood after reviewing the following descriptions and drawings.

FIG. 1 indicates an overview perspective of a wagon that has the Beach Skis attached with the velcro straps on each wheel/tire individually.

FIG. 2 shows a close-up view of the Beach Ski without the velcro straps in place with indication as to how to attach them to the wheel/tire.

FIG. 3 is a top view of the Beach Ski with the velcro strap in place over the wheel/tire.

### DETAILED DESCRIPTION OF THE INVENTION

The following statements will be referencing the images in more detail with like numerals that are used throughout the drawings to depict like or similar elements of the Beach Skis device. The drawings are intended for representative purposes only and should not be considered to be limiting in any respect.

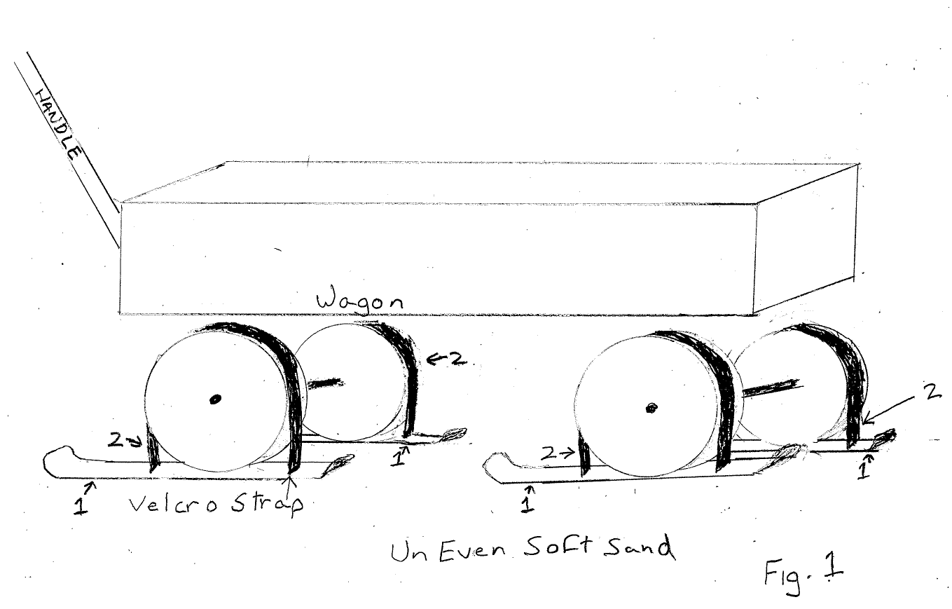

FIG. 1 shows an overview perspective of a wagon that has the Beach Skis 1 attached with velcro straps 2 on each wheel/tire individually. The Beach Skis are made to be reusable or biodegradable/disposable depending on the choice of the consumer. This design can be made of a biodegradable wood product or a lifelong plastic or PVC material.

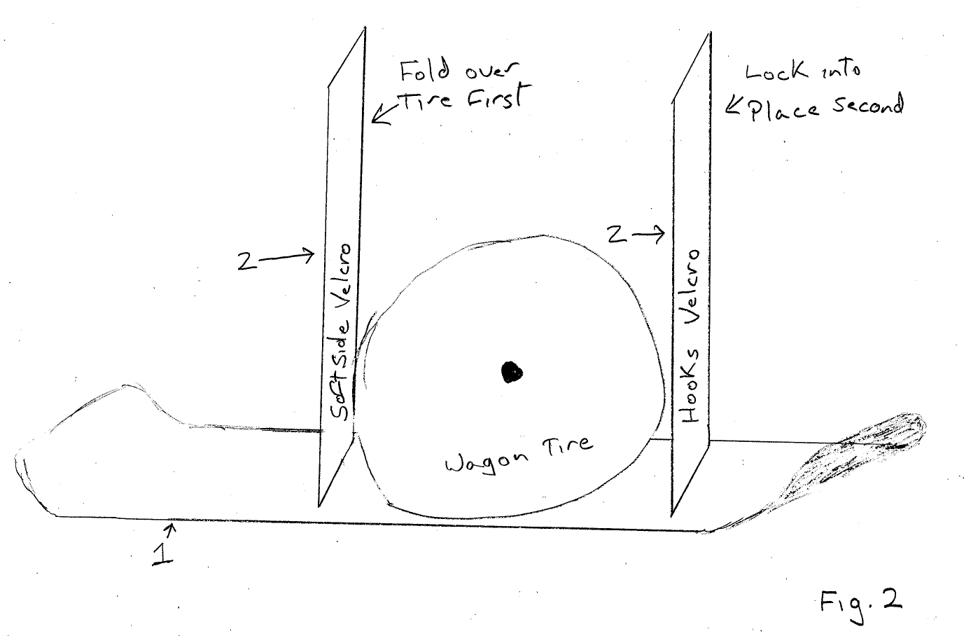

FIG. 2 is the close-up view of the Beach Ski. This shows the wheel/tire sitting on top of the Beach Ski 1 with the velcro strap 2 not yet put into place, but indicating how the straps would be secured.

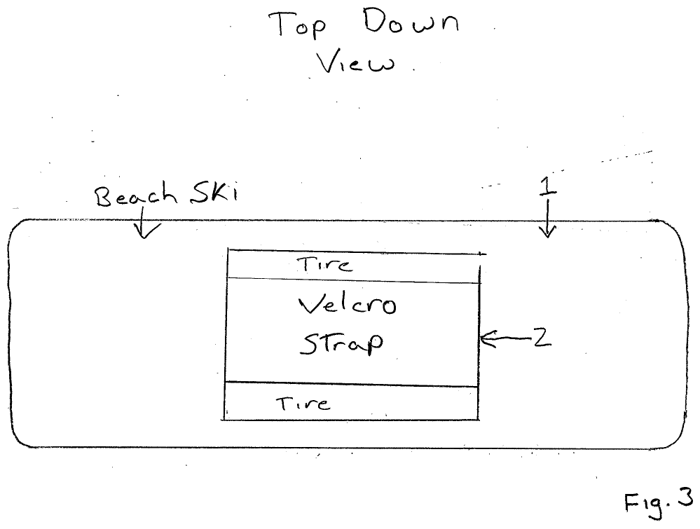

FIG. 3 is the top view of the Beach Ski 1 with the velcro strap 2 in place securing the Beach Ski to the wheel/tire.

1. The Beach Ski can change your ordinary wheeled wagon, cooler, small trailer or any other small item with wheels/tires that is hard to pull due to a soft surface material into one that glides over the soft material much easier and with less effort.

2. The Beach Ski of claim 1 can be attached with a velcro strap to each individual wheel/tire to easily slide/glide/move on the sand in just three easy steps.

3. The Beach Ski in claim 1 can be biodegradable if consumer chooses the biodegradable material.

4. The Beach Ski in claim 1 can be either disposable or reusable depending on the material chosen by the consumer.
